(19) United States
(12) Patent Application Publication
(10) Pub. No.: US 2026/0051809 A1
(43) Pub. Date: Feb. 19, 2026

(54) VOLTAGE CONVERSION CIRCUIT AND VOLTAGE CONVERSION SYSTEM

(71) Applicant: DELTA ELECTRONICS, INC., Taoyuan City (TW)

(72) Inventors: Hung-Chieh LIN, Taoyuan City (TW); Yi-Ping HSIEH, Taoyuan City (TW); Jin-Zhong HUANG, Taoyuan City (TW); Hung-Yu HUANG, Taoyuan City (TW)

(21) Appl. No.: 19/270,443

(22) Filed: Jul. 15, 2025

(30) Foreign Application Priority Data
Aug. 16, 2024 (CN) 202411127816.0

(51) Int. Cl. H02M 1/14; H02M 1/12; H02M 1/42; H02M 7/219

(52) U.S. Cl. CPC H02M 1/14; H02M 1/126; H02M 1/4208; H02M 7/219

(57) ABSTRACT

A voltage conversion circuit coupled to an alternating current (AC) input source and comprising an electronic circuit and a filter circuit is provided. The electronic circuit is coupled between positive and negative buses. The filter circuit reduces ripples of the AC input source and comprises a first capacitor, a second capacitor, a filter inductor and a first inductor. The first capacitor is coupled to the positive bus. The second capacitor is coupled to the first capacitor to form a common node, and coupled to the negative bus. Two terminals of the filter inductor are respectively coupled to the AC input source and the common node. A terminal of the first inductor is coupled to the common node. When the AC input source flows into the filter circuit from the common node, ripples of the AC input source are absorbed by at least one of the first and second capacitors.

### RELATED APPLICATIONS

This application claims priority of China application No. 202411127816.0, filed on Aug. 16, 2024, which is herein incorporated by reference in its entirety.

### BACKGROUND

### Technical Field

The present disclosure relates to the technology of voltage conversion circuit. More particularly, the present disclosure relates to a voltage conversion circuit and a voltage conversion system that can absorb the ripples of input current.

### Description of Related Art

For the demands of voltage types in various situations, the voltage conversion circuits for the conversion from alternating current to direct current (AC-DC) and from direct current to alternating current (DC-AC) are widely used to convert voltages into the required types. However, there is a problem of ripples in input current of today's voltage conversion circuits, causing the input current to easily become unstable.

In order to reduce the ripples in the input current, today's approach is usually to increase the inductance in the circuit or use an out-of-phase control method to control the signal. However, these methods will lead to an increase in circuit volume, thereby increasing manufacturing costs. Therefore, how to overcome the problem of the ripples in the input current without significantly increasing the circuit volume is one of the topics in this field.

### SUMMARY

A voltage conversion circuit is provided in the present disclosure. The voltage conversion circuit is coupled to an AC input source and comprises an electronic circuit and a filter circuit. The electronic circuit is coupled between a positive bus and a negative bus. The filter circuit is configured to reduce ripples of the AC input source and comprises a first capacitor, a second capacitor, a filter inductor and a first inductor. A first terminal of the first capacitor is coupled to the positive bus. A first terminal of the second capacitor is coupled to a second terminal of the first capacitor to form a common node, and a second terminal of the second capacitor is coupled to the negative bus. A first terminal and a second terminal of the filter inductor are respectively coupled to the AC input source and the common node. A first terminal of the first inductor is coupled to the common node, and a second terminal of the first inductor is electrically coupled to a neutral voltage of the electronic circuit. When the AC input source flows into the filter circuit from the common node, the ripples of the AC input source are absorbed by at least one of the first capacitor and the second capacitor.

A voltage conversion system is provided in the present disclosure. The voltage conversion system comprises a plurality of voltage conversion circuits. Each of the plurality of voltage conversion circuits is coupled to an AC input source, jointly coupled to a positive bus, and jointly coupled to a negative bus. Each of the plurality of voltage conversion circuits comprises an electronic circuit and a filter circuit. The electronic circuit is coupled between the positive bus and the negative bus. The filter circuit is configured to reduce ripples of the AC input source and comprises a first capacitor, a second capacitor, a filter inductor and a first inductor. A first terminal of the first capacitor is coupled to the positive bus. A first terminal of the second capacitor is coupled to a second terminal of the first capacitor to form a common node, and a second terminal of the second capacitor is coupled to the negative bus. A first terminal and a second terminal of the filter inductor are respectively coupled to the AC input source and the common node. A first terminal of the first inductor is coupled to the common node, and a second terminal of the first inductor is electrically coupled to a neutral voltage of the electronic circuit. When the AC input source flows into the filter circuit from the common node, the ripples of the AC input source are absorbed by at least one of the first capacitor and the second capacitor.

With the voltage conversion circuits and the voltage conversion systems in the present disclosure, the ripples of the input current can be absorbed by using a filter circuit, thereby improving the stability of the circuit and system without significantly increasing the circuit volume.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows.

FIG. 1A is a circuit diagram of a voltage conversion circuit in accordance with some instances.

FIG. 1B is a circuit diagram of a voltage conversion circuit in accordance with some instances.

FIG. 1C is a timing diagram of a voltage conversion circuit in accordance with the instances of FIG. 1A and FIG. 1B.

FIG. 2 is a circuit diagram of a voltage conversion circuit in accordance with some embodiments of the present disclosure.

FIG. 3A is a schematic diagram of the current directions of the voltage conversion circuit in one mode in accordance with the embodiment of FIG. 2.

FIG. 3B is a schematic diagram of the current directions of the voltage conversion circuit in another mode in accordance with the embodiment of FIG. 2.

FIG. 3C is a schematic diagram of the current directions of the voltage conversion circuit in yet another mode in accordance with the embodiment of FIG. 2.

FIG. 3D is a schematic diagram of the current directions of the voltage conversion circuit in yet another mode in accordance with the embodiment of FIG. 2.

FIG. 4 is a timing diagram of the voltage conversion circuit in accordance with the embodiment of FIG. 2.

FIG. 5 is a circuit diagram of a voltage conversion circuit in accordance with some embodiments of the present disclosure.

FIG. 6A is a schematic diagram of the current directions of the voltage conversion circuit in one mode in accordance with the embodiment of FIG. 5.

FIG. 6B is a schematic diagram of the current directions of the voltage conversion circuit in another mode in accordance with the embodiment of FIG. 5.

FIG. 6C is a schematic diagram of the current directions of the voltage conversion circuit in yet another mode in accordance with the embodiment of FIG. 5.

FIG. 6D is a schematic diagram of the current directions of the voltage conversion circuit in yet another mode in accordance with the embodiment of FIG. 5.

FIG. 7A is a circuit diagram of a voltage conversion circuit in accordance with some embodiments of the present disclosure.

FIG. 7B is a circuit diagram of a voltage conversion circuit in accordance with some embodiments of the present disclosure.

FIG. 8 is a circuit diagram of a voltage conversion system in accordance with some embodiments of the present disclosure.

FIG. 9A is a circuit diagram of a voltage conversion system in accordance with some embodiments of the present disclosure.

FIG. 9B is a circuit diagram of a voltage conversion system in accordance with some embodiments of the present disclosure.

### DETAILED DESCRIPTION

Reference will now be made in detail to the present embodiments of the disclosure, examples of which are illustrated in the accompanying drawings.

In the present disclosure, when an element is referred to as “connected”, it may mean “electrically connected” or “optical connected”. When an element is referred to as “coupled”, it may mean “electrically coupled” or “optical coupled”. “Connected” or “coupled” can also be used to indicate that two or more components operate or interact with each other. As used in the present disclosure, the singular forms “a”, “one” and “the” are also intended to include plural forms, unless the context clearly indicates otherwise. It will be further understood that when used in this specification, the terms “comprises (comprising)” and/or “includes (including)” designate the existence of stated features, steps, operations, elements and/or components, but the existence or addition of one or more other features, steps, operations, elements, components, and/or groups thereof are not excluded.

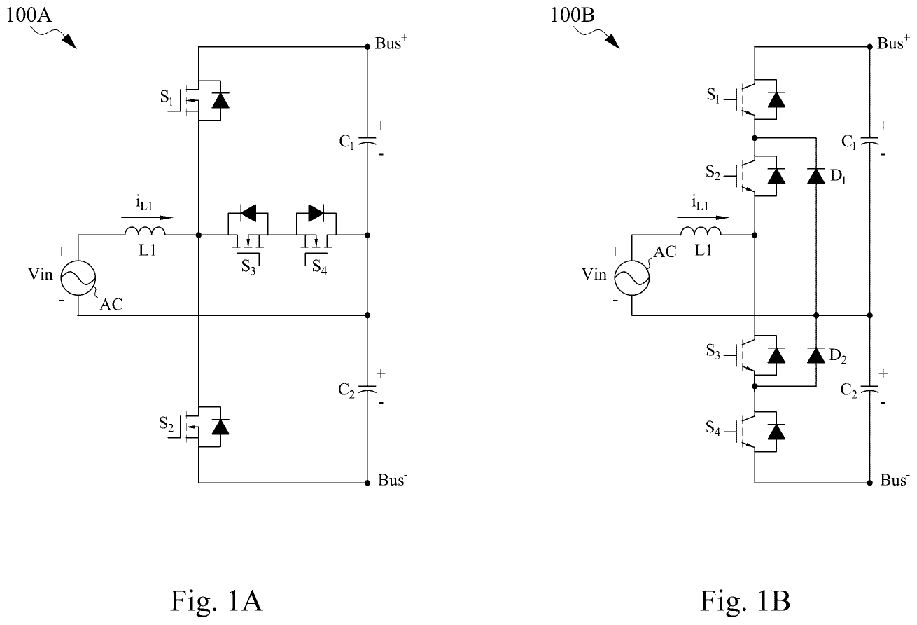

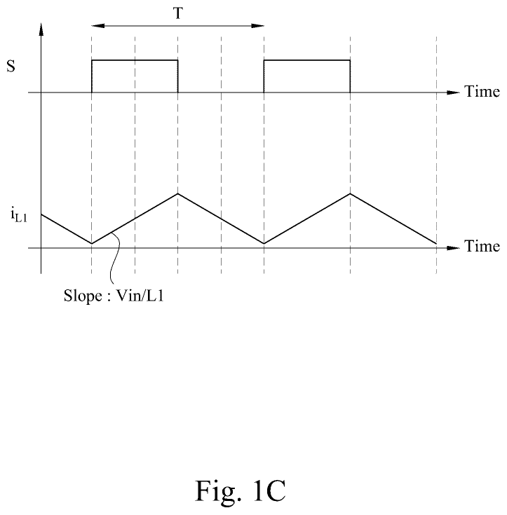

FIG. 1A and FIG. 1B are circuit diagrams of voltage conversion circuits 100A and 100B in accordance with some instances. The voltage conversion circuit 100A is coupled to an input source AC and comprises an inductor L1, switches S₁-S₄ and capacitors C₁, C₂. In some instances, the voltage conversion circuit 100A may also be referred to as a power factor correction (PFC) circuit. In addition, in some instances not shown, at least one of the switches S₁, S₂ may be implement with diodes.

The voltage conversion circuit 100B is coupled to the input source AC and comprises a inductor L1, switches S₁-S₄, diodes D₁, D₂ and capacitors C₁, C₂. In some instances, the voltage conversion circuit 100B may also be referred to as a neutral point clamped (NPC) circuit.

FIG. 1C is a timing diagram of the voltage conversion circuits 100A, 100B in accordance with the instances of FIG. 1A and FIG. 1B. During each cycle T, when the switches S₁-S₄ (collectively referred to as switches S) are turned on (i.e., the switches S in FIG. 1B have a higher voltage level), the input source AC will start to charge the inductor L1 and generate an input current i_{L1}, and the input current i_{L1} will rise as the inductor L1 is charged, wherein its rising slope is Vin/L1. Next, when the switches S are turned off (i.e., the switches S in FIG. 1B have a lower voltage level), the inductor L1 will start to discharge, and at this time the input current i_{L1} will fall as the inductor L1 discharges.

Due to the multiple rises and falls of the input current i_{L1} during the charging and discharging of the inductor L1, ripples are generated, and the ripples will reduce the stability of the input current i_{L1}. In order to mitigate the impact of ripples of the input current i_{L1}, in certain instances, the inductance of the circuit will be increased, or an out-of-phase control method will be applied to decrease the magnitude of the ripples. Under such adjustments, the circuit volume and manufacturing cost of the voltage conversion circuits 100A, 100B tend to increase.

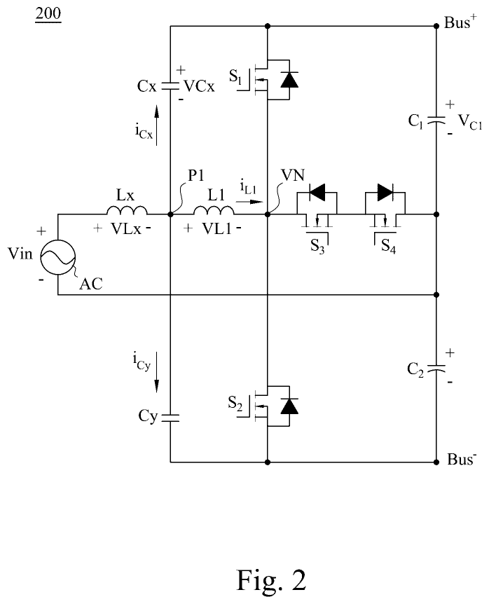

FIG. 2 is a circuit diagram of a voltage conversion circuit 200 in accordance with some embodiments of the present disclosure. Compared with the voltage conversion circuit 100A in FIG. 1A and FIG. 1B, the voltage conversion circuit 200 not only comprises an electronic circuit similar to the voltage conversion circuit 100A, but also comprises a filter circuit formed by inductors L1, Lx and capacitors Cx, Cy. In other words, the voltage conversion circuit 200 is improved based on the tradition PFC circuit.

In detail, in some embodiments, the voltage conversion circuit 200 is coupled to the input source AC and comprises an electronic circuit and a filter circuit. The electronic circuit comprises switches S₁-S₄ and capacitors C₁, C₂, and the filter circuit comprises an inductor Lx and capacitors Cx, Cy.

The input source AC is coupled to a first terminal of the inductor Lx, coupled to a node between the capacitors C₁, C₂, and is configured to generate an input voltage Vin. The inductor Lx is coupled between the input source AC and a first terminal of the inductor L1 (hereinafter referred to as “the common node P1”), and is configured to generate a corresponding current according to its voltage VLx. The inductor L1 is coupled to a second terminal of the inductor Lx (i.e., the common node P1), electrically coupled to a neutral voltage VN of the electronic circuit, and is configured to generate the corresponding input current i_{L1} according to its voltage VL1.

The capacitors Cx and Cy are coupled to the common node P1, respectively coupled to a positive bus Bus⁺ and a negative bus Bus⁻, and are configured to respectively generate currents i_{Cx}, i_{Cy} according to their voltages, wherein the capacitor Cx has a voltage VCx. The capacitors C₁ and C₂ are coupled in series between the positive bus Bus⁺ and the negative bus Bus⁻, wherein the capacitor C₁ has a voltage V_{C1}.

The switch S₁ is electrically coupled to the neutral voltage VN of the electronic circuit and coupled to the positive bus Bus⁺; the switch S₂ is electrically coupled to the neutral voltage VN of the electronic circuit and coupled to the negative bus Bus⁻; the switches S₃ and S₄ are coupled to the neutral voltage VN of the electronic circuit and coupled to the node between the capacitors C₁, C₂. In some embodiments, the switches S₃ and S₄ can be integrated into a single switch circuit.

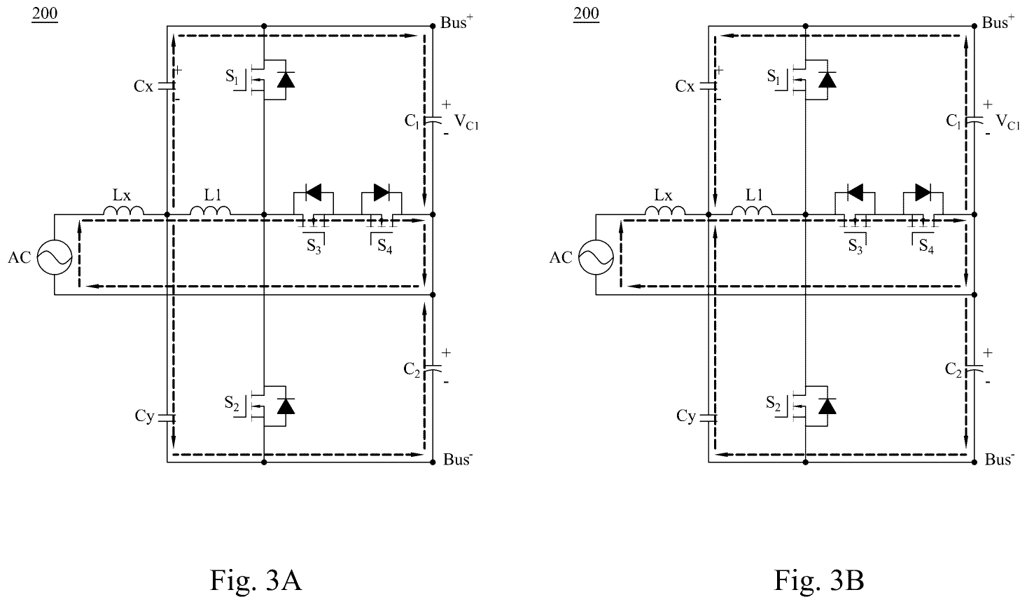

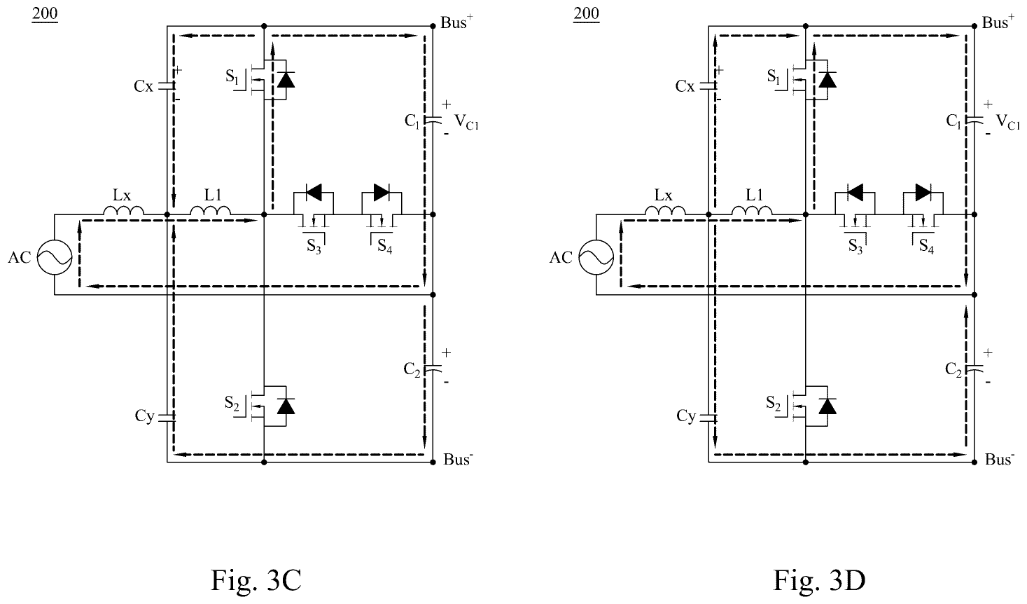

In some embodiments, each of the switches S₁-S₄ in the voltage conversion circuit 200 has a specific on/off configuration in various modes, so that the input current it can be substantially equal to zero. For example, in one mode (e.g., FIG. 3A, which will be described in detail in following paragraphs), the switches S₁, S₂ are turned off and the switches S₃, S₄ are turned on. According to Kirchhoff's voltage law, VLx=Vin+VCx−V_{C1} and VL1=Vin-VLx at this time. In another mode (e.g., FIG. 3C, which will be described in detail in following paragraphs), the switch S₁ is turned on and the switch S₃ is turned off. According to Kirchhoff's voltage law, VLx=Vin+VCx-V_{C1} and VL2=−VCx at this time.

Assume that the ratio of time that switch S₃ is turned on in a cycle T is D (i.e., the turned-on time is DT). According to the volt second balance principle, VCx=Vin*D/(1-D) and V_{C1}=Vin/(1−D). By substituting these equations to the aforementioned equations, the voltage VL1 of the inductor L1 will be equal to zero. Since the voltage VL1 of the inductor L1 is zero, the input current i_{L1} can remain free of current ripples.

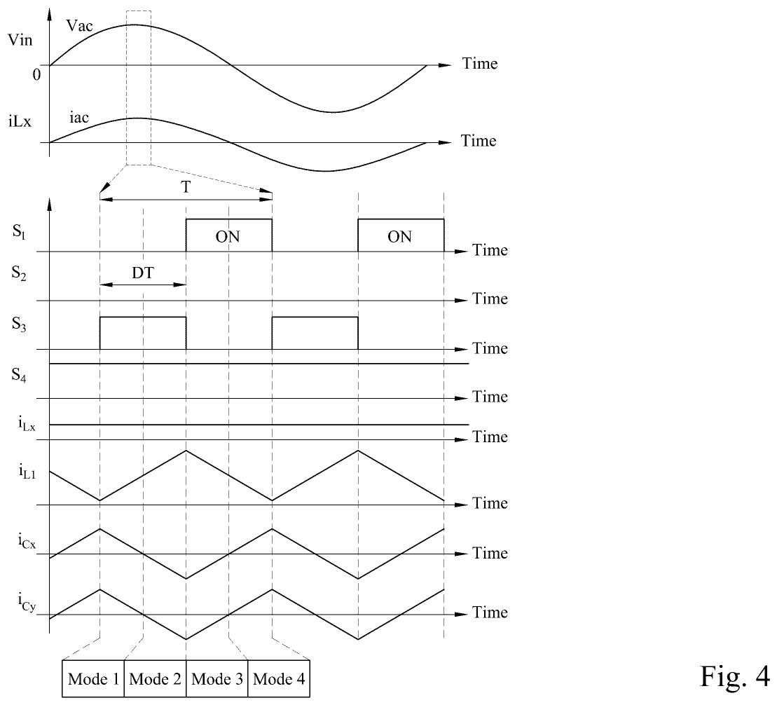

Please refer to FIGS. 3A-3D and FIG. 4 together. FIGS. 3A-3D are schematic diagrams of the current directions of the voltage conversion circuit 200 in various modes in accordance with the embodiment of FIG. 2. FIG. 4 is a timing diagram of the voltage conversion circuit 200 in accordance with the embodiment of FIG. 2. The current directions of the voltage conversion circuit 200 and the conduction states of the switches S₁-S₄ in FIGS. 3A-3D respectively correspond to the Mode 1 to Mode 4 in FIG. 4.

In the embodiment of FIG. 4, the input voltage Vin is an AC voltage Vac varying over time, thereby generating an AC current iac varying over time on the inductor Lx. In each specific cycle T (marked with a dotted block), the voltage conversion circuit 200 sequentially executes Mode 1 to Mode 4.

In the embodiment of FIG. 3A (i.e., the Mode 1 shown in FIG. 4), the input source AC is in a positive half cycle. At this time, the input source AC flows into the filter circuit from the common node P1, the switches S₁, S₂ are turned off, and the switches S₃, S₄ are turned on, so as to charge the capacitors Cx, Cy. In addition, at this time, the currents i_{Cx}, i_{Cy} flow from the common node P1 through the capacitors Cx, Cy to the positive bus Bus⁺ and the negative bus Bus⁻ respectively, and the input source AC, the inductors Lx, L1 and the switches S₃, S₄ form a loop in which current flows in a clockwise direction.

In the embodiment of FIG. 3B (i.e., the Mode 2 shown in FIG. 4), the input source AC is also in the positive half cycle, and the switches S₁-S₄ remain the same conduction states as before to continue charging the capacitors Cx, Cy. The difference from the embodiment in FIG. 3A is that the currents i_{Cx}, i_{Cy} at this time respectively flow from the positive bus Bus⁺ and the negative bus Bus through the capacitors Cx, Cy to the common node P1.

In the embodiment of FIG. 3C (i.e., the Mode 3 shown in FIG. 4), the input source AC is also in the positive half cycle, but the capacitors Cx, Cy have been charged for a predetermined time. At this time, the switch S₁ is turned on, and the switch S₃ is turned off, so as to discharge the capacitors Cx, Cy. In addition, at this time, the currents i_{Cx}, i_{Cy} respectively flow from the positive bus Bus⁺ and the negative bus Bus⁻ through the capacitors Cx, Cy to the common node P1, and the input source AC, the inductors Lx, L1 and the switch S₁ form a loop in which current flows in a clockwise direction.

In the embodiment of FIG. 3D (i.e., the Mode 4 shown in FIG. 4), the input source AC is also in the positive half cycle, and the switches S₁-S₄ remain the same conduction states as before to continue discharging the capacitors Cx, Cy. The difference from the embodiment in FIG. 3C is that the currents i_{Cx}, i_{Cy} flow from the common node P1 through the capacitors Cx, Cy to the positive bus Bus⁺ and the negative bus Bus⁻ respectively.

Since the capacitors Cx, Cy can absorb the ripples on the inductor L1, the problem caused by the ripples in input current of tradition voltage conversion circuits can be solved. In addition, since the input current i_{L1} have no ripples, the voltage conversion circuit 200 may select an inductor with lower inductance as the inductor Lx, thereby reduce the circuit volume and manufacturing cost.

Furthermore, in some embodiments not shown, when the input source AC enters a negative half cycle, the switches S₁-S₄ of the voltage conversion circuit 200 are turned on/off in the same configuration as the positive half cycle in Mode 1 and Mode 2, but the switch S₂ is turn on instead of switch S₁ (i.e., switch S₁ remains off) in Mode 3 and Mode 4.

Moreover, in other embodiments not shown, the currents in the voltage conversion circuit 200 can flow in the direction opposite to the current directions shown in FIGS. 3A-3D. For the sake of brevity, the detail will not be repeated here.

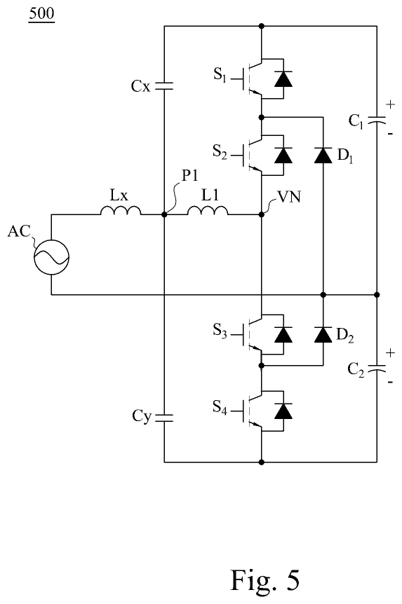

FIG. 5 is a circuit diagram of a voltage conversion circuit 500 in accordance with some embodiments of the present disclosure. Similar to the voltage conversion circuit 200 of FIG. 2, the voltage conversion circuit 500 of FIG. 5 also comprises a filter circuit and an electronic circuit. The difference is that the electronic circuit of the voltage conversion circuit 500 is similar to the voltage conversion circuit 100B in FIG. 1B. In other words, the voltage conversion circuit 500 is improved based on the tradition NPC circuit.

The filter circuit of the voltage conversion circuit 500 is similar to the filter circuit of the voltage conversion circuit 200. For the sake of brevity, the detail will not be repeated here.

In some embodiments, the electronic circuit of the voltage conversion circuit 500 comprises switches S₁-S₄, diodes D₁, D₂ and capacitors C₁, C₂. The switches S₁ and S₂ are coupled to the positive bus Bus⁺ in series and electrically coupled to the neutral voltage VN of the electronic circuit. The switches S₃ and S₄ are coupled to the negative bus Bus⁻ in series and electrically coupled to the neutral voltage VN of the electronic circuit. The diode D₁ is coupled to the node between the switches S₁, S₂ and coupled to the node between the capacitors C₁, C₂. The diode D₂ is coupled to the node between the switches S₃, S₄ and coupled to the node between the capacitors C₁, C₂. In some embodiments not shown, the diodes D₁, D₂ can be replaced by a capacitor or a combination of multiple capacitors.

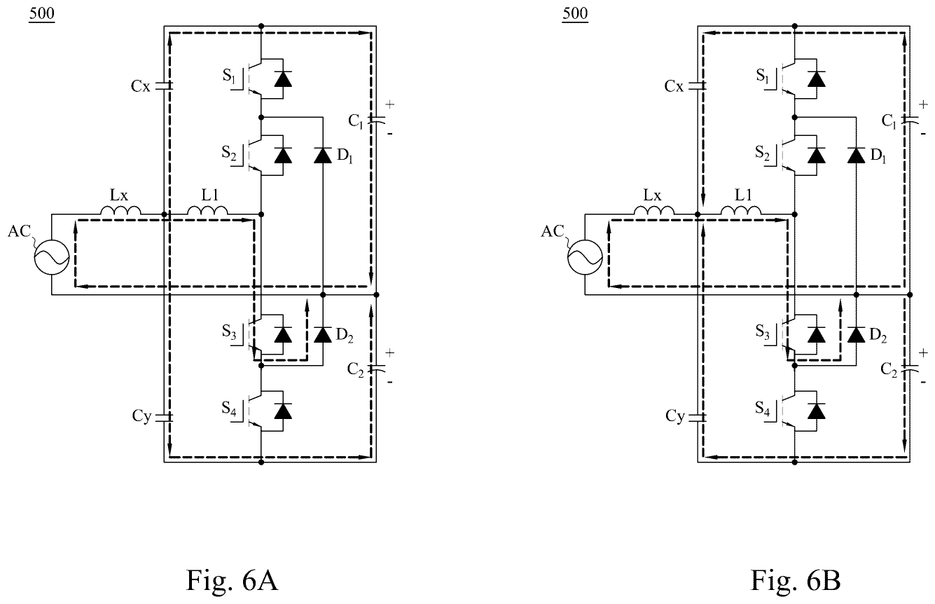

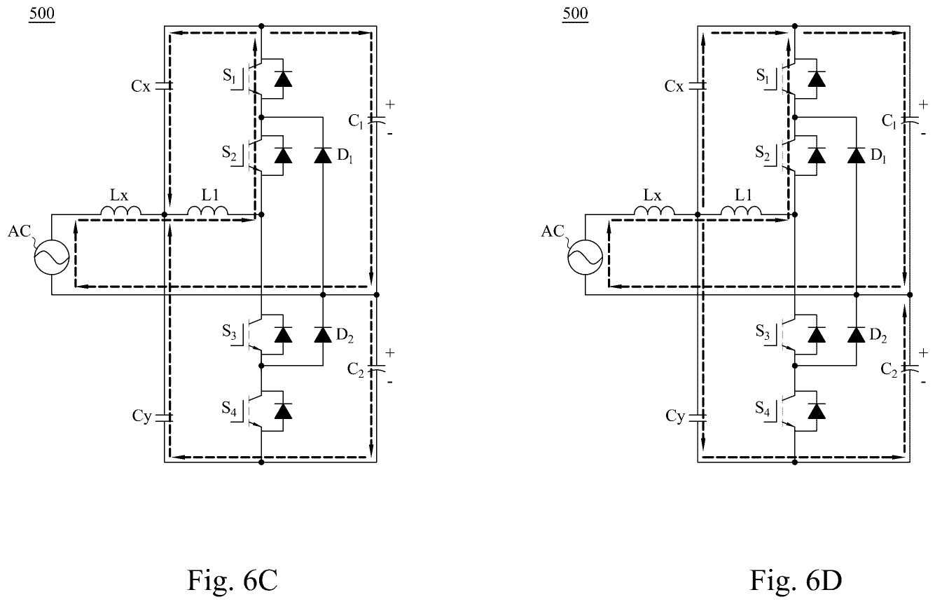

Similar to the voltage conversion circuit 200, the switches S₁-S₄ of the voltage conversion circuit 500 are also turned on and turned off according to various modes. Please refer to FIGS. 6A-6D. FIGS. 6A-6D are schematic diagrams of the current directions of the voltage conversion circuit 500 in various modes in accordance with the embodiment of FIG. 5.

In the embodiment of FIG. 6A, the input source AC is in the positive half cycle. At this time, the input source AC flows into the filter circuit from the common node P1, the switches S₁, S₂, S₄ are turned off, and the switch S₃ is turned on, so as to charge the capacitors Cx, Cy. In addition, at this time, the currents i_{Cx}, i_{Cy} flow from the common node P1 through the capacitors Cx, Cy to the positive bus Bus⁺ and the negative bus Bus⁻ respectively, and the input source AC, the inductors Lx, L1, the switch S₃ and the diode D₂ form a current loop.

In the embodiment of FIG. 6B, the input source AC is also in the positive half cycle, and the switches S₁-S₄ remain the same conduction states as before to continue charging the capacitors Cx, Cy. The difference from the embodiment in FIG. 6A is that the currents i_{Cx}, i_{Cy} at this time respectively flow from the positive bus Bus⁺ and the negative bus Bus⁻ through the capacitors Cx, Cy to the common node P1.

In the embodiment of FIG. 6C, the input source AC is also in the positive half cycle, but the capacitors Cx, Cy have been charged for a predetermined time. At this time, the switches S₁, S₂ are turned on, and the switch S32 is turned off, so as to discharge the capacitors Cx, Cy. In addition, at this time, the currents i_{Cx}, icy respectively flow from the positive bus Bus⁺ and the negative bus Bus⁻ through the capacitors Cx, Cy to the common node P1, and the input source AC, the inductors Lx, L1, the switches S₁, S₂ and the capacitor C₁ form a current loop.

In the embodiment of FIG. 6D, the input source AC is also in the positive half cycle, and the switches S₁-S₄ remain the same conduction states as before to continue discharging the capacitors Cx, Cy. The difference from the embodiment in FIG. 6C is that the currents i_{Cx}, i_{Cy} flow from the common node P1 through the capacitors Cx, Cy to the positive bus Bus⁺ and the negative bus Bus respectively.

Similar to the voltage conversion circuit 200, since the capacitors Cx, Cy can absorb the ripples on the inductor L1, the voltage conversion circuit 500 can overcome the problem caused by the ripples in input current of tradition voltage conversion circuits, thereby reduce the circuit volume and manufacturing cost.

Furthermore, in some embodiments not shown, when the input source AC enters the negative half cycle and charges the capacitors C₁ and C₂, the switches S₁, S₂, S₄ of the voltage conversion circuit 500 are turned off, and the switch S₂ is turn on; when the input source AC is in the negative half cycle and discharges the capacitors C₁ and C₂, the switches S₃, S₄ of the voltage conversion circuit 500 are turned on, and the switches S₁, S₂ are turned off.

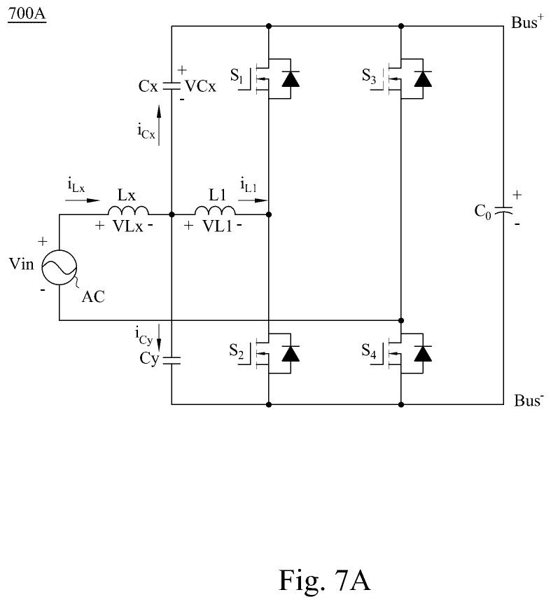

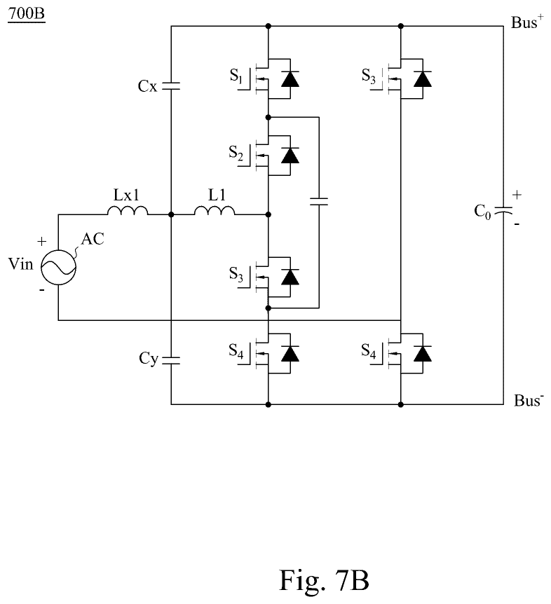

In some embodiments, there may be only one capacitor between the positive bus Bus⁺ and the negative bus Bus⁻ connected by the voltage conversion circuit disclosed in the present disclosure. Please refer to FIG. 7A. FIG. 7A is a circuit diagram of a voltage conversion circuit 700A in accordance with some embodiments of the present disclosure. The voltage conversion circuit 700A is similar to the voltage conversion circuit 200 of FIG. 2, and has a similar function to the voltage conversion circuit 200 (i.e., absorbing the ripples of current by charging/discharging the capacitors Cx and Cy). The difference is that there is only a capacitor C₀ between the positive bus Bus⁺ and the negative bus Bus connected by the voltage conversion circuit 700A, the switches S₃ and S₄ are coupled in series between the positive bus Bus⁺ and the negative bus Bus⁻, and the input source AC is coupled to the node between the switches S₃ and S₄.

FIG. 7B is a circuit diagram of a voltage conversion circuit 700B in accordance with some embodiments of the present disclosure. The voltage conversion circuit 700B is similar to the voltage conversion circuit 500 of FIG. 5, and has a similar function to the voltage conversion circuit 500 (i.e., absorbing the ripples of current by charging/discharging the capacitors Cx and Cy). The difference is that there is only a capacitor C₀ between the positive bus Bus⁺ and the negative bus Bus⁻ connected by the voltage conversion circuit 700B, the diodes D₁ and D₂ are replaced by a capacitor, the voltage conversion circuit 700B further comprises switches S₃ and S₄ coupled in series between the positive bus Bus⁺ and the negative bus Bus⁻, and the input source AC is coupled to the node between the switches S₃ and S₄.

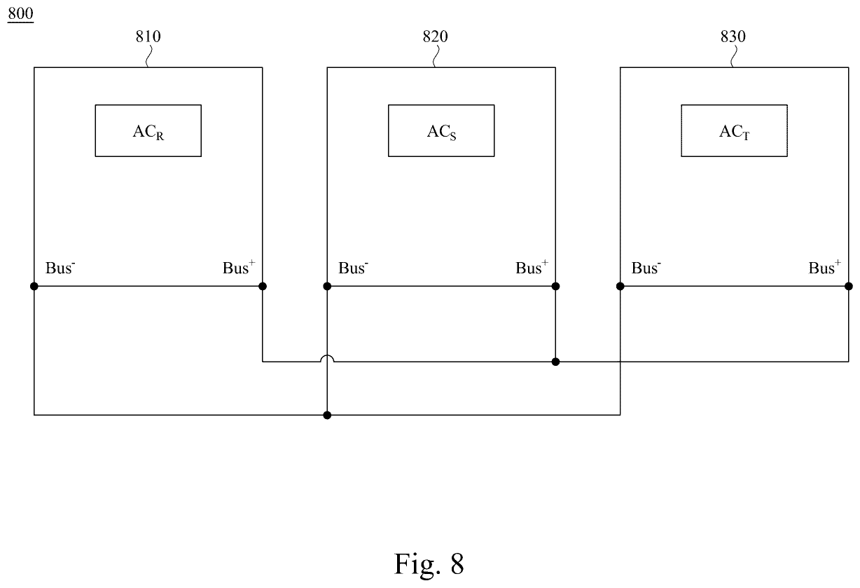

In some embodiments, a combination of multiple voltage conversion circuits (e.g., the voltage conversion circuits 200, 500, 700A, 700B, etc.) can implement a multi-phase voltage conversion system. Please refer to FIG. 8. FIG. 8 is a circuit diagram of a voltage conversion system 800 in accordance with some embodiments of the present disclosure. In some embodiments, the voltage conversion system 800 comprises voltage conversion circuits 810, 820 and 830, wherein each of the voltage conversion circuits 810, 820 and 830 can be implemented with any one the aforementioned voltage conversion circuits 200, 500, 700A and 700B.

The voltage conversion circuits 810, 820 and 830 are commonly coupled to the same positive bus Bust, and commonly coupled to the same negative bus Bus. In some embodiments, the voltage conversion circuits 810, 820 and 830 are coupled to input sources AC_{R}, AC_{S} and AC_{T} respectively, and the AC voltages output by the input sources AC_{R}, AC_{S} and AC_{T} respectively have different phases. Therefore, the voltage conversion system 800 can achieve a three-phase voltage conversion system.

It should be noted that the number of voltage conversion circuits in the voltage conversion system 800 in FIG. 8 is only an example, and is not intended to limit the present disclosure. Other numbers of voltage conversion circuits are within the scope of the present disclosure. In some embodiments, the voltage conversion system in the present disclosure may comprise more than four voltage conversion circuits corresponding to different phases.

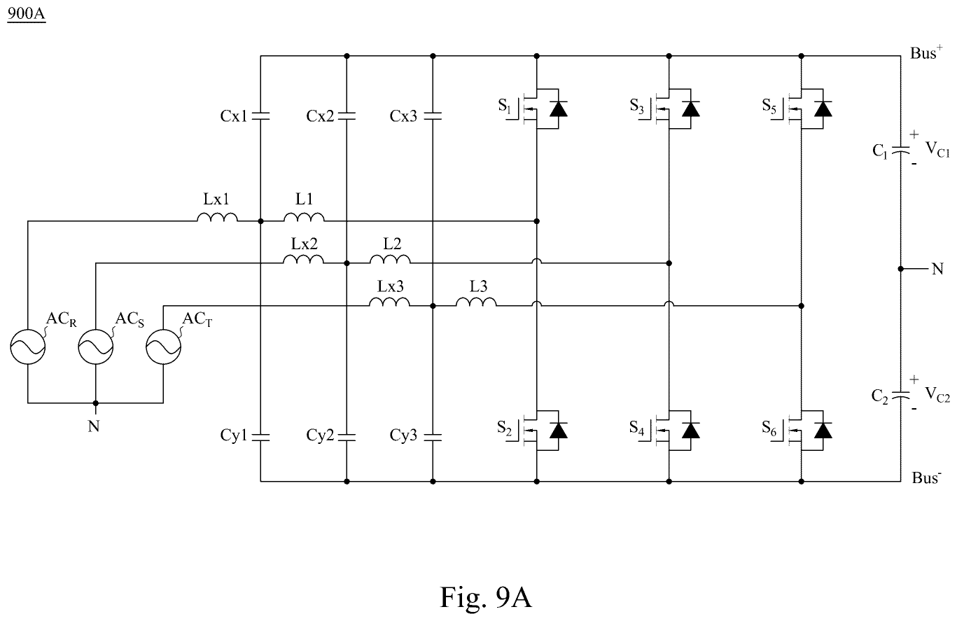

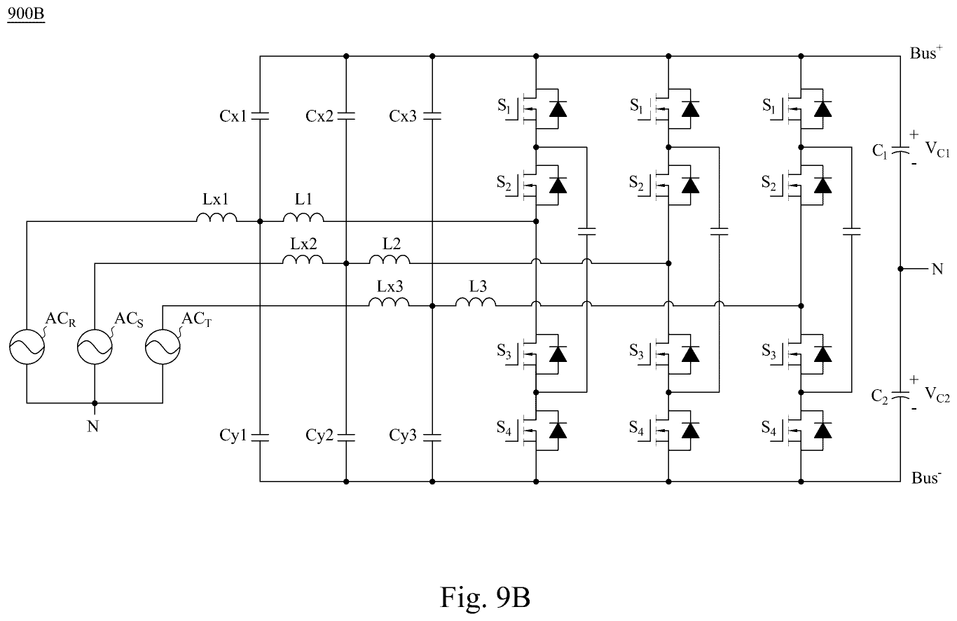

FIG. 9A is a circuit diagram of a voltage conversion system 900A in accordance with some embodiments of the present disclosure. The voltage conversion system 900A is a system formed by the voltage conversion circuit 200 of FIG. 2 and the voltage conversion circuit 800 of FIG. 8. Therefore, the voltage conversion system 900A can implement a three-phase voltage conversion system, wherein its capacitors Cx1, Cy1 can absorb the ripples of current on the inductor L1, its capacitors Cx2, Cy2 can absorb the ripples of current on the inductor L2, and its capacitors Cx3, Cy3 can absorb the ripples of current on the inductor L3.

FIG. 9B is a circuit diagram of a voltage conversion system 900B in accordance with some embodiments of the present disclosure. The voltage conversion system 900B is a system formed by the voltage conversion circuit 500 of FIG. 5 and the voltage conversion circuit 800 of FIG. 8. Therefore, the voltage conversion system 900B can implement a three-phase voltage conversion system, wherein its capacitors Cx1, Cy1 can absorb the ripples of current on the inductor L1, its capacitors Cx2, Cy2 can absorb the ripples of current on the inductor L2, and its capacitors Cx3, Cy3 can absorb the ripples of current on the inductor L3.

In addition, as mentioned above, there may be only one capacitor between the positive bus Bust and the negative bus Bus. Therefore, in some embodiments not shown, there may be only one capacitor between the positive bus Bus⁺ and the negative bus Bus⁻ connected by the voltage conversion system 900A of FIG. 9A, and there may be only one capacitor between the positive bus Bus⁺ and the negative bus Bus⁻ connected by the voltage conversion system 900B of FIG. 9B.

With the voltage conversion circuits and the voltage conversion systems in the present disclosure, the ripples of the input current can be absorbed by the filter circuit, thereby improving the stability of the circuit and system. In addition, since an inductor with a lower inductance can be used in the filter circuits, the voltage conversion circuits and voltage conversion systems in the present disclosure can solve the problem of a significant increase in circuit volume and manufacturing cost.

The above are preferred embodiments of the present disclosure. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. A voltage conversion circuit, coupled to an AC input source and comprising:
an electronic circuit, coupled between a positive bus and a negative bus; and
a filter circuit, configured to reduce ripples of the AC input source and comprising:
a first capacitor, wherein a first terminal of the first capacitor is coupled to the positive bus;
a second capacitor, wherein a first terminal of the second capacitor is coupled to a second terminal of the first capacitor to form a common node, and a second terminal of the second capacitor is coupled to the negative bus;
a filter inductor, wherein a first terminal and a second terminal of the filter inductor are respectively coupled to the AC input source and the common node; and
a first inductor, wherein a first terminal of the first inductor is coupled to the common node, and a second terminal of the first inductor is electrically coupled to a neutral voltage of the electronic circuit,
wherein when the AC input source flows into the filter circuit from the common node, the ripples of the AC input source are absorbed by at least one of the first capacitor and the second capacitor.

2. The voltage conversion circuit of claim 1, wherein the electronic circuit comprises:
a first switch, electrically coupled to the neutral voltage of the electronic circuit and coupled to the positive bus;
a second switch, electrically coupled to the neutral voltage of the electronic circuit and coupled to the negative bus;
a third switch; and
a fourth switch, wherein the third switch and the fourth switch are coupled in series and coupled to the neutral voltage of the electronic circuit.

3. The voltage conversion circuit of claim 2, wherein during a positive half cycle of the AC input source, the AC input source flows into the filter circuit from the common node, the first switch and the second switch are turned off, and the third switch and the fourth switch are turned on, to charge the first capacitor and the second capacitor.

4. The voltage conversion circuit of claim 3, wherein after the first capacitor and the second capacitor are charged for a predetermined time, the first switch is turned on and the third switch is turned off.

5. The voltage conversion circuit of claim 2, wherein during a negative half cycle of the AC input source, the AC input source flows into the filter circuit from the common node, the first switch and the second switch are turned off, and the third switch and the fourth switch are turned on, to charge the first capacitor and the second capacitor.

6. The voltage conversion circuit of claim 5, wherein after the first capacitor and the second capacitor are charged for a predetermined time, the second switch is turned on and the third switch is turned off.

7. The voltage conversion circuit of claim 2, wherein the electronic circuit further comprises at least one third capacitor coupled between the positive bus and the negative bus.

8. The voltage conversion circuit of claim 1, wherein the electronic circuit comprises:
a first switch, coupled to the positive bus;
a second switch, electrically coupled to the neutral voltage of the electronic circuit and coupled to the first switch;
a third switch, electrically coupled to the neutral voltage of the electronic circuit and;
a fourth switch, coupled between the third switch and the negative bus;
a first diode, coupled between the AC input source and a node between the first switch and the second switch; and
a second diode, coupled between the AC input source and a node between the third switch and the fourth switch.

9. The voltage conversion circuit of claim 8, wherein during a positive half cycle of the AC input source, the AC input source flows into the filter circuit from the common node, the first switch, the second switch and the fourth switch are turned off, and the third switch is turned on, to charge the first capacitor and the second capacitor.

10. The voltage conversion circuit of claim 9, wherein after the first capacitor and the second capacitor are charged for a predetermined time, the first switch is turned on and the third switch is turned off.

11. The voltage conversion circuit of claim 8, wherein during a negative half cycle of the AC input source, the AC input source flows into the filter circuit from the common node, the first switch, the third switch and the fourth switch are turned off, and the second switch is turned on, to charge the first capacitor and the second capacitor.

12. The voltage conversion circuit of claim 11, wherein after the first capacitor and the second capacitor are charged for a predetermined time, the third switch and the fourth switch are turned on, and the second switch is turned off.

13. The voltage conversion circuit of claim 8, wherein the electronic circuit further comprises at least one third capacitor coupled between the positive bus and the negative bus.

14. A voltage conversion system, comprising:
a plurality of voltage conversion circuits, each coupled to an AC input source, jointly coupled to a positive bus, and jointly coupled to a negative bus, wherein each of the plurality of voltage conversion circuits comprises:
an electronic circuit, coupled between the positive bus and the negative bus; and
a filter circuit, configured to reduce ripples of the AC input source and comprising:
a first capacitor, wherein a first terminal of the first capacitor is coupled to the positive bus;
a second capacitor, wherein a first terminal of the second capacitor is coupled to a second terminal of the first capacitor to form a common node, and a second terminal of the second capacitor is coupled to the negative bus;
a filter inductor, wherein a first terminal and a second terminal of the filter inductor are respectively coupled to the AC input source and the common node; and
a first inductor, wherein a first terminal of the first inductor is coupled to the common node, and a second terminal of the first inductor is electrically coupled to a neutral voltage of the electronic circuit,
wherein when the AC input source flows into the filter circuit from the common node, the ripples of the AC input source are absorbed by at least one of the first capacitor and the second capacitor.

15. The voltage conversion system of claim 14, wherein the electronic circuit comprises:
a first switch, electrically coupled to the neutral voltage of the electronic circuit and coupled to the positive bus;
a second switch, electrically coupled to the neutral voltage of the electronic circuit and coupled to the negative bus;
a third switch; and
a fourth switch, wherein the third switch and the fourth switch are coupled in series and coupled to the neutral voltage of the electronic circuit.

16. The voltage conversion system of claim 15, wherein during a positive half cycle of the AC input source, the AC input source flows into the filter circuit from the common node, the first switch and the second switch are turned off, and the third switch and the fourth switch are turned on, to charge the first capacitor and the second capacitor.

17. The voltage conversion system of claim 16, wherein after the first capacitor and the second capacitor are charged for a predetermined time, the first switch is turned on and the third switch is turned off.

18. The voltage conversion system of claim 15, wherein during a negative half cycle of the AC input source, the AC input source flows into the filter circuit from the common node, the first switch and the second switch are turned off, and the third switch and the fourth switch are turned on, to charge the first capacitor and the second capacitor.

19. The voltage conversion system of claim 18, wherein after the first capacitor and the second capacitor are charged for a predetermined time, the second switch is turned on and the third switch is turned off.

20. The voltage conversion system of claim 14, wherein the electronic circuit comprises:
a first switch, coupled to the positive bus;
a second switch, electrically coupled to the neutral voltage of the electronic circuit and coupled to the first switch;
a third switch, electrically coupled to the neutral voltage of the electronic circuit and;
a fourth switch, coupled between the third switch and the negative bus;
a first diode, coupled between the AC input source and a node between the first switch and the second switch; and
a second diode, coupled between the AC input source and a node between the third switch and the fourth switch.
